(19) United States
(12) Patent Application Publication
(10) Pub. No.: US 2023/0077488 A1
(43) Pub. Date: Mar. 16, 2023

(54) Core Data Augmentation Methods For Developing Data Driven Based Petrophysical Interpretation Models

(71) Applicant: Halliburton Energy Services, Inc., Houston, TX (US)

(72) Inventors: Wei Shao, Conroe, TX (US); Songhua Chen, Katy, TX (US)

(73) Assignee: Halliburton Energy Services, Inc., Houston, TX (US)

(21) Appl. No.: 17/471,345

(22) Filed: Sep. 10, 2021

(51) Int. Cl. G06N 20/10; G06K 9/62; E21B 43/00

(52) U.S. Cl. CPC G06N 20/10; G06K 9/6273; E21B 43/00; G06K 9/6256; E21B 2200/22

(57) ABSTRACT

A method for training a model. The method may include forming a data set from one or more measurements of core samples, selecting one or more parameters from the data set, inputting the one or more parameters into a kernel estimation function, determining a kernel density estimation from the kernel estimation function based at least in part on the one or more parameters, and selecting an input value based at least in part on the kernel density estimation. The method may further include creating a corresponding synthetic target value based at least in part on the input value, augmenting the data set with the corresponding synthetic target value and input value to form a synthetic data set, and training a petrophysical interpretation machine learning model from the data set and the synthetic data set.

### BACKGROUND

Geospatial maps and models may be utilized for the discovery and exploitation of desirable subterranean fluids (e.g., hydrocarbons). In particular, geological and petrophysical data related to said maps and models may aid in optimizing the development of hydrocarbon-bearing subterranean formations, estimating the total volume of recoverable hydrocarbons, forecasting production volumes, and identifying future targets for hydrocarbon exploration and development. The geological and petrophysical data derived from said maps and models may be utilized for independent assessments or may function as an input to other models including reservoir flow simulations, hydraulic fracturing models, pre-drill production estimates, subsidence models, data augmentation algorithms, and machine learning (ML). Developing such models may involve a variety of data, including, the collection and utilization of core data. For data-driven or ML-based petrophysical interpretation models, the amount of core data needed for training may be directly related to the complexity of the model. Some ML models, such as deep learning models, have many hyper-parameters. Having access to a large repository of core data when training an associated ML model may be beneficial with respect to avoiding model overfitting.

Core data provides a high level of detail regarding the geological and petrophysical properties of the target formation, however core samples and the associated data may be expensive to procure. Therefore, core data may only be gathered on a few select wells which have been identified by technical specialists (ex: geologists, geophysicists, petrophysicists, and petroleum engineers) as being located in a particular area of interest. Additionally, core data is often treated as a confidential or proprietary asset wherein such data may not be frequently shared between companies. Given the limited number of core samples collected, it may be challenging to extrapolate and generalize the core dataset across a large geospatial area. Thus, a low or insufficient quantity of core samples may be prohibitive to generating useful or functional geospatial maps and models due to the lack of data across a geospatial area of interest.

### BRIEF DESCRIPTION OF THE DRAWINGS

These drawings illustrate certain aspects of some examples of the present disclosure and should not be used to limit or define the disclosure.

FIG. 1 illustrates an example of a core drilling operation;

FIG. 2 illustrates a schematic view of an information handling system;

FIG. 3 illustrates is another schematic view of the information handling system;

FIG. 4 is a schematic view of a network;

FIG. 5 illustrates a Radial Basis Mapping Function;

FIG. 6 is a graph illustrating measured resonance of one or more core samples;

FIG. 7A depicts a variance of Principal Component Analysis; and

FIG. 7B depicts the first 8 Principal Component Analysis components from FIG. 7A.

### DETAILED DESCRIPTION

This disclosure details a method and system for augmenting a data set comprised of measured data collected from rock samples known as cores. The quantity and geographic distribution of the collected data may be sparse in comparison to the geographic area over which the data needs to be applied. Generally, the systems and methods discussed below relate to a system and method for utilizing Radial Basis Mapping Function (RBF) to augment a core sample dataset. RBF iterates through the obtained core sample dataset, estimates a kernel function, and estimates a corresponding synthetic target value. In another example, Principal Component Analysis may be utilized to generate synthetic data of the obtained core sample dataset. In both examples, the synthetic target value or synthetic data is joined into the originally obtained dataset resulting in an augmented dataset.

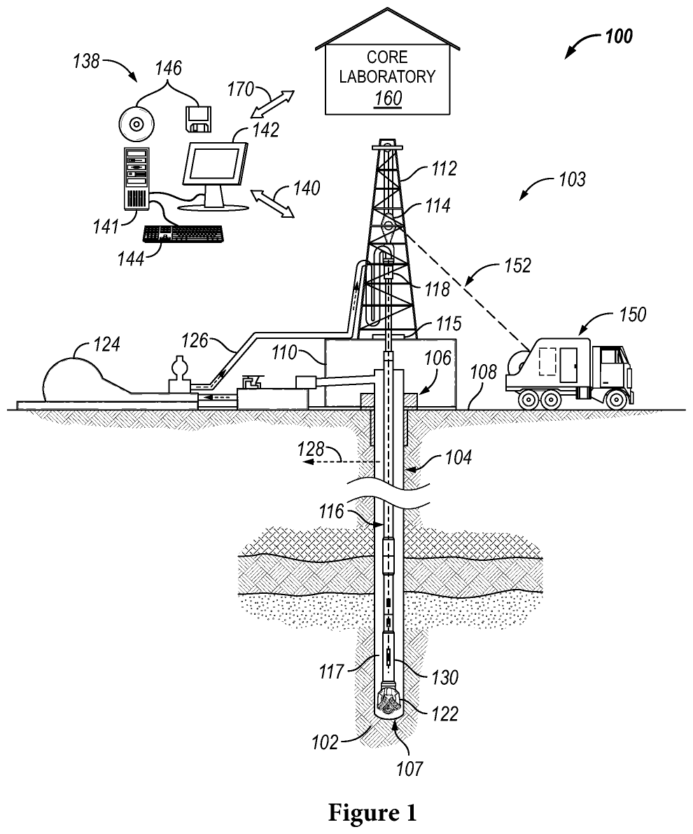

As illustrated in FIG. 1, the geological subsurface domain may consist of multiple subterranean rock layers which, as a non-limiting example, may be classified and categorized by depositional age, depositional environment, or geologic properties to create one or more subterranean formations 100. In particular, one or more target subterranean formations may exist as a subset of the subterranean formations 100, wherein the target subterranean formations 102 may have an interstitial pore space that contains at least hydrocarbons. FIG. 1 further illustrates an example embodiment of a wellbore drilling system 103 which may be used to create a borehole 104 which fluidly couples target subterranean formation 102 to the surface 108. During downhole operations, wellbore drilling system 103 may perform operations for the cutting and collection of core samples wherein the execution of this operation may further include the cutting and collection of core samples. As illustrated, borehole 104 may extend from a wellhead 106 into a subterranean formation 102 from a surface 108. Generally, borehole 104 may include horizontal, vertical, slanted, curved, and other types of borehole geometries and orientations. Borehole 104 may be cased or uncased. In examples, borehole 104 may include a metallic member. By way of example, the metallic member may be a casing, liner, tubing, or other elongated steel tubular disposed in borehole 104.

Borehole 104 may extend through subterranean formations 100. As illustrated in FIG. 1, borehole 104 may extend generally vertically into subterranean formations 100, however borehole 104 may extend at an angle through subterranean formations 100, such as horizontal and slanted boreholes. For example, although FIG. 1 illustrates a vertical or low inclination angle well, high inclination angle or horizontal placement of the well and equipment may be possible. It should further be noted that while FIG. 1 generally depict land-based operations, those skilled in the art may recognize that the principles described herein are equally applicable to subsea operations that employ floating or sea-based platforms and rigs, without departing from the scope of the disclosure.

As illustrated, a drilling platform 110 may support a derrick 112 having a traveling block 114 for raising and lowering drill string 116. Drill string 116 may include, but is not limited to, drill pipe and coiled tubing, as generally known to those skilled in the art. A kelly 118 may support drill string 116 as it may be lowered through a rotary table 120. A drill bit 122 may be attached to the distal end of drill string 116 and may be driven either by a downhole motor and/or via rotation of drill string 116 from surface 108. Without limitation, drill bit 122 may include, roller cone bits, PDC bits, natural diamond bits, any hole openers, reamers, coring bits, and the like. As drill bit 122 rotates, it may create and extend borehole 104 that penetrates various subterranean formations 100. Proximally disposed to the drill bit may be a bottom hole assembly (BHA) 117 which without limitation may comprise stabilizers, reamers, mud motors, logging while drilling (LWD) tools, measurement while drilling (MWD) or directional drilling tools, heavy-weight drill pipe, drilling collars, jars, coring tools, and underreaming tools. A pump 124 may circulate drilling fluid through a feed pipe 126 through kelly 118, downhole through interior of drill string 116, through orifices in drill bit 122 back to surface 108 via annulus 128 surrounding drill string 116, and into a retention pit (not shown).

With continued reference to FIG. 1, drill string 116 may begin at wellhead 106 and may traverse borehole 104. Drill bit 122 may be attached to a distal end of drill string 116 and may be driven, for example, either by a downhole motor and/or via rotation of drill string 116 from surface 108. Drill bit 122 and drill string 116 may be progressed through one or more subterranean formations 100 until target subterranean formation 102 is reached.

Drill string 116, drill bit 122 and drilling BHA 117 may be removed from the well, through a process called “tripping out of hole,” or a similar process. A coring bit 122 and coring BHA 117 are installed on drill string 116 which is then run back into borehole 104 through a process which may be called “tripping in hole,” or a similar process. The face of coring bit 122 may consist of a toroidal cutting edge with a hollow center that extends full-bore through the body of coring bit 122. With coring bit 122 being the endmost piece of equipment in BHA 117, disposed proximally thereto is a rock sample containment vessel which may be known as a core barrel 130. Once coring bit 122 is in contact with the bottom of the borehole 107 it is rotationally engaged with target subterranean formation 102 to cut and disengage a portion of target subterranean formation 102 in the form of a core. As coring bit 122 progresses further into target subterranean formation 102, the portion of the rock that is disengaged from target subterranean formation 102 is progressively encased in a core barrel 130 until the entirety of the sample is disengaged from target subterranean formation 102 and encased within core barrel 130. In some embodiments the core sample is relayed from core barrel 130 to the rig floor 115 by removing drill string 116 from borehole 104. In non-limiting alternate embodiments, a wireline truck 150 and a wireline, electric line, braided cable, or slick line 152 may be used to relay core barrel 130 through the center of drill string 116 to rig floor 115.

As illustrated, communication link 140 (which may be wired or wireless, for example) may be provided that may transmit data during the coring operation from BHA 117 to an information handling system 138 at surface 108. Information handling system 138 may include a personal computer 141, a video display 142, a keyboard 144 (i.e., other input devices.), and/or non-transitory computer-readable media 146 (e.g., optical disks, magnetic disks) that may store code representative of the methods described herein. In addition to, or in place of processing at surface 108, processing may also occur downhole as information handling system 138 may be disposed on BHA 117. As discussed above, the software, algorithms, and modeling are performed by information handling system 138. Information handling system 138 may perform steps, run software, perform calculations, and/or the like automatically, through automation (such as through artificial intelligence (“AI”), dynamically, in real-time, and/or substantially in real-time.

Once retrieved from borehole 104, the at least one core may be packaged and transported to a core laboratory 160 where a multitude of tests may be performed to identify create a core sample data set which may be populated with geological and petrophysical features wherein some non-limiting examples include formation sedimentology, mineralogy, formation wettability, fluid saturations and distributions, formation factor, pore structure and pore volume, capillary pressure behavior, sediment grain density, horizontal and vertical permeability and relative permeabilities, porosity, and presence of diagenesis. Communication link 170 may be configured to transmit data during core analysis operations in core laboratory 160 to an information handling system 138. The data obtained during the petrophysical analysis in core laboratory 160 may be stored in a structured database or in an unstructured form on an information handling system 138 which may include a personal computer 141, a video display 142, a keyboard 144 (i.e., other input devices.), and/or non-transitory computer-readable media 146 (e.g., optical disks, magnetic disks) that may store code representative of the methods described herein. In addition to, or in place of processing at core laboratory 160, processing related to the collection of the core data set may also take place offsite from core laboratory 160. As discussed above, the software, algorithms, and modeling are performed by information handling system 138. Information handling system 138 may perform steps, run software, perform calculations, and/or the like automatically, through automation (such as through artificial intelligence (“AI”), dynamically, in real-time, and/or substantially in real-time.

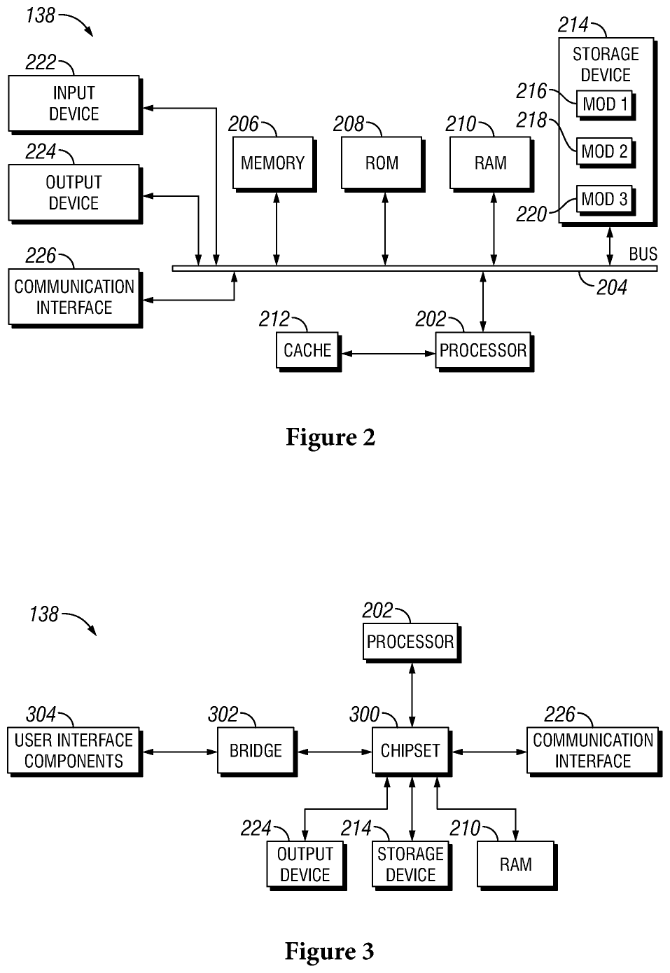

FIG. 2 illustrates an example information handling system 138 which may be employed to perform various steps, methods, and techniques disclosed herein. Persons of ordinary skill in the art will readily appreciate that other system examples are possible. As illustrated, information handling system 138 includes a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 138 may include a cache 212 of high-speed memory connected directly with, in close proximity to, or integrated as part of processor 202. Information handling system 138 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. Other system memory 206 may be available for use as well. Memory 206 may include multiple different types of memory with different performance characteristics. It may be appreciated that the disclosure may operate on information handling system 138 with more than one processor 202 or on a group or cluster of computing devices networked together to provide greater processing capability. Processor 202 may include any general-purpose processor and a hardware module or software module, such as first module 216, second module 218, and third module 220 stored in storage device 214, configured to control processor 202 as well as a special-purpose processor where software instructions are incorporated into processor 202. Processor 202 may be a self-contained computing system, containing multiple cores or processors, a bus, memory controller, cache, etc. A multi-core processor may be symmetric or asymmetric. Processor 202 may include multiple processors, such as a system having multiple, physically separate processors in different sockets, or a system having multiple processor cores on a single physical chip. Similarly, processor 202 may include multiple distributed processors located in multiple separate computing devices but working together such as via a communications network. Multiple processors or processor cores may share resources such as memory 206 or cache 212 or may operate using independent resources. Processor 202 may include one or more state machines, an application specific integrated circuit (ASIC), or a programmable gate array (PGA) including a field PGA (FPGA).

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 138, such as during start-up. Information handling system 138 further includes storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may include software modules 216, 218, and 220 for controlling processor 202. Information handling system 138 may include other hardware or software modules. Storage device 214 is connected to the system bus 204 by a drive interface. The drives and the associated computer-readable storage devices provide nonvolatile storage of computer-readable instructions, data structures, program modules and other data for information handling system 138. In one aspect, a hardware module that performs a particular function includes the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 138 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 138 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 138, an input device 222 represents any number of input mechanisms, such as a microphone for speech, a touch-sensitive screen for gesture or graphical input, keyboard, mouse, motion input, speech and so forth. Additionally, input device 222 may receive core samples or data derived from core samples obtained in core laboratory 160, discussed above. An output device 224 may also be one or more of a number of output mechanisms known to those of skill in the art. In some instances, multimodal systems enable a user to provide multiple types of input to communicate with information handling system 138. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component describe above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general purpose processor. For example, the functions of one or more processors presented in FIG. 2 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 208 for storing software performing the operations described below, and random-access memory (RAM) 210 for storing results. Very large-scale integration (VLSI) hardware embodiments, as well as custom VLSI circuitry in combination with a general-purpose DSP circuit, may also be provided.

FIG. 3 illustrates an example information handling system 138 having a chipset architecture that may be used in executing the described method and generating and displaying a graphical user interface (GUI). Information handling system 138 is an example of computer hardware, software, and firmware that may be used to implement the disclosed technology. Information handling system 138 may include a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may include, for example, magnetic media, and solid-state media. Chipset 300 may also read data from and write data to RAM 210. A bridge 302 for interfacing with a variety of user interface components 304 may be provided for interfacing with chipset 300. Such user interface components 304 may include a keyboard, a microphone, touch detection and processing circuitry, a pointing device, such as a mouse, and so on. In general, inputs to information handling system 138 may come from any of a variety of sources, machine generated and/or human generated.

Chipset 300 may also interface with one or more communication interfaces 226 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 202 analyzing data stored in storage device 214 or RAM 210. Further, information handling system 138 receive inputs from a user via user interface components 304 and execute appropriate functions, such as browsing functions by interpreting these inputs using processor 202.

In examples, information handling system 138 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

During drilling operations information handling system 138 may process different types of the real time data originated from varied sampling rates and various sources, such as diagnostics data, sensor measurements, operations data, and or the like through core laboratory 160. (e.g., referring to FIG. 1). These measurements from the BHA 117 may allow for information handling system 138 to perform real-time health assessment of the coring operation.

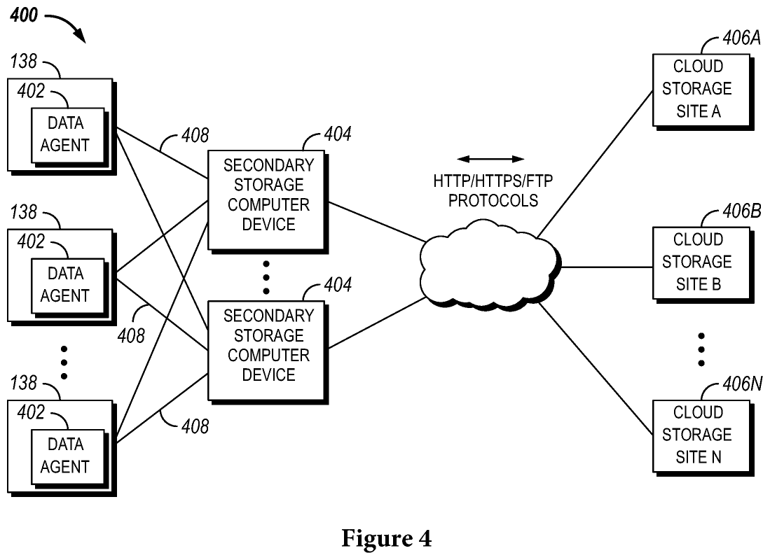

FIG. 4 illustrates an example of one arrangement of resources in a computing network 400 that may employ the processes and techniques described herein, although many others are of course possible. As noted above, an information handling system 138, as part of their function, may utilize data, which includes files, directories, metadata (e.g., access control list (ACLS) creation/edit dates associated with the data, etc.), and other data objects. The data on the information handling system 138 is typically a primary copy (e.g., a production copy). During a copy, backup, archive or other storage operation, information handling system 138 may send a copy of some data objects (or some components thereof) to a secondary storage computing device 165 by utilizing one or more data agents 402.

A data agent 402 may be a desktop application, website application, or any software-based application that is run on information handling system 138. As illustrated, information handling system 138 may be disposed at any rig site (e.g., referring to FIG. 1) or repair and manufacturing center. The data agent may communicate with a secondary storage computing device 404 using communication protocol 408 in a wired or wireless system. The communication protocol 408 may function and operate as an input to a website application. In the website application, field data related to pre- and post-operations, generated DTCs, notes, and the like may be uploaded. Additionally, information handling system 138 may utilize communication protocol 408 to access processed measurements, operations with similar DTCs, troubleshooting findings, historical run data, and/or the like. This information is accessed from secondary storage computing device 404 by data agent 402, which is loaded on information handling system 138.

Secondary storage computing device 404 may operate and function to create secondary copies of primary data objects (or some components thereof) in various cloud storage sites 406A-N. Additionally, secondary storage computing device 404 may run determinative algorithms on data uploaded from one or more information handling systems 138, discussed further below. Communications between the secondary storage computing devices 404 and cloud storage sites 406A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 406A-N, the secondary storage computing device 404 may also perform local content indexing and/or local object-level, sub-object-level or block-level deduplication when performing storage operations involving various cloud storage sites 406A-N. Cloud storage sites 406A-N may further record and maintain DTC code logs for each downhole operation or run, map DTC codes, store repair and maintenance data, store operational data, and/or provide outputs from determinative algorithms that are located in cloud storage sites 406A-N. In a non-limiting example, this type of network may be utilized as a platform to store, backup, analyze, import, preform extract, transform and load (“ETL”) processes, mathematically process, apply machine learning algorithms, and augment a core sample data set.

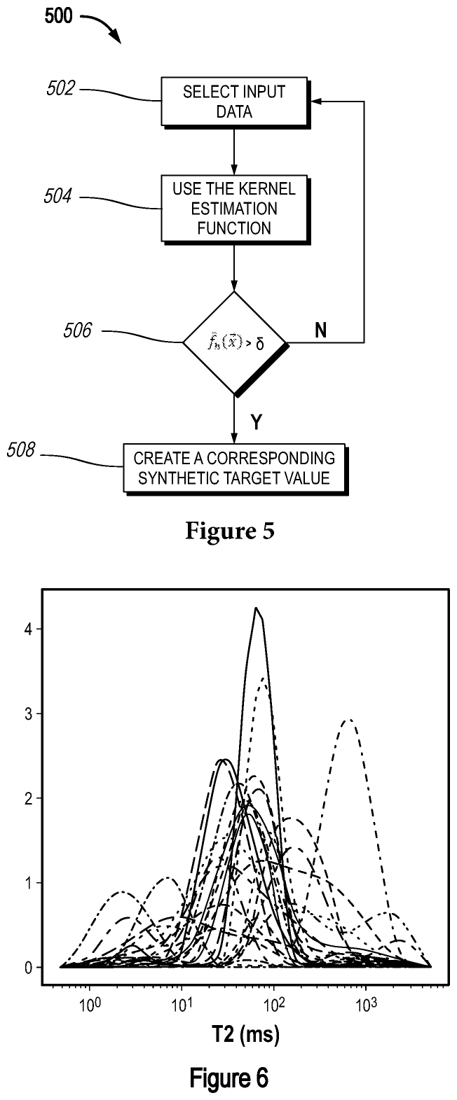

FIG. 5 illustrates a primary data augmentation technique 500. Primary data augmentation technique 500 may be a Radial Basis Mapping Function (RBF). An RBF may generally depend on the distance between an input and some fixed or target point. RBF may consider a relationship between input and target data is continuous. As previously described, the core sample data set obtained by core laboratory 160 (e.g., referring to FIG. 1) may be stored within information handling system 138 (e.g., referring to FIG. 1). Additionally, Primary data augmentation technique 500 may be performed on information handling system 138 and may be populated with core sample data set obtained by core laboratory 160. Primary data augmentation technique 500 produces synthetic data from core sample data which when added or augmented to core sample data set obtained by core laboratory 160 producing an augmented dataset.

For the methods and systems discussed above, let {\vec{x}ᵢ,\vec{y}ᵢ}ᵢ₌₁^{i=N} be the input and target data in the training data set, where each \vec{x}ᵢ and \vec{y}ᵢ represent the petrophysical properties, which may be identified as a parameter, of each core sample obtained by core laboratory 160. For example, \vec{x}ᵢ and \vec{y}ᵢ may be vectors with one or more parameters or numerical values with a single parameter. Additionally, \vec{x}ᵢ may be a single core sample and a vector of (Vₚ, Vₛ, ϕ, T_{2,gm}). Where Vₚ is acoustic P-wave velocity, Vₛis acoustic S-wave velocity, ϕ is total porosity, and T_{2,gm} is NMR T₂ log mean. It should be noted, in regard to T₁ and T₂, the decay of RF-induced NMR spin polarization is characterized in terms of two separate processes, each with their own time constants. One process, called T₁, is responsible for the loss of resonance intensity following pulse excitation. The other process, called T₂, characterizes the width or broadness of resonances. Stated more formally, is the time constant for the physical processes responsible for the relaxation of the components of the nuclear spin magnetization vector M parallel to the external magnetic Field, B₀ (which is conventionally designated as the z-axis). T₂ relaxation affects the coherent components of M perpendicular to B₀. In conventional NMR spectroscopy, T₁ limits the pulse repetition rate and affects the overall time an NMR spectrum can be acquired. Values of T₁ range from milliseconds to several seconds, depending on the size of the molecule, the viscosity of the solution, the temperature of the sample, and the possible presence of paramagnetic species (e.g., O₂ or metal ions).

Furthermore, formation factor \vec{y}ᵢ is the ratio of the resistivity of the core sample filled with water Ro to the resistivity of the water Rw wherein the core is the rock sample procured during the coring process previously described in FIG. 1. As noted above, formation factor \vec{y}ᵢ may be a single parameter. However, in other examples, formation factor \vec{y}ᵢ may be one or more parameters. In block 502, a single \vec{x}ᵢ is selected from the core sample data set obtained by core laboratory 160. The selected single \vec{x}ᵢ is applied in block 504 to determine a kernel estimation function. The kernel density estimation #\hat{f}ₕ(\vec{x}) is used to measure the proximality of a synthetic input \vec{x} to the input data in the training dataset {\vec{x}ᵢ}ᵢ₌₁^{i=N}. It is defined as:

$${\hat{f}}_{h} ( \vec{x} ) = \frac{1}{N} {\sum }_{i = 1}^{N} {K}_{h} ( \vec{x} - {\vec{x}}_{i} ) \qquad ( 1 )$$

where Kₕ is a kernel and may be a symmetric function that integrates to one and h is the kernel size or bandwidth which may be predefined and/or adjustable. Kₕ may be any type of kernel including but not limiting a Gaussian kernel, linear kernel, or cosine kernel. In a non-limiting example, a kernel function may be defined as: Kₕ(\vec{x})=N(0, h²), with normal distribution of mean=0 and standard deviation h.

In block 506 the kernel density estimation \hat{f}ₕ(\vec{x}) calculated in block 504 is compared to a threshold δ. Where δ is a predefined parameter to ensure the synthetic input data \vec{x} in the applicable ranges is defined by the input data in the training dataset {\vec{x}ᵢ}ᵢ₌₁^{i=N}. If \hat{f}ₕ(\vec{x})>δ then RBF continues to block 508, otherwise primary data augmentation technique 500 moves back to block 502 and iterates a new \vec{x}ᵢ. In examples, δ may be altered to allow different applications of RBF.

As previously stated, if \hat{f}ₕ(\vec{x})>δ block 508 a corresponding synthetic target value is created with the RBF mapping function is defined in the following form:

\vec{F}(\vec{x})=Σᵢ₌₁^{N}\vec{c}ᵢϕ(∥\vec{x}−\vec{x}ᵢ∥) (2)

where {\vec{c}ᵢ_{ₖ}}ₖ₌₁^{N} is and where ϕ referred as the Radial Basis Function, and ∥\vec{x}−\vec{x}ᵢ∥ is the Euclidean distance between \vec{x} and \vec{x}ᵢ. In a non-limiting example, ϕ is the Normalized Gaussian function and the RBF mapping function is then in the following form:

$$\vec{F} ( \vec{x} ) = \frac{{\sum }_{i = 1}^{N} {\vec{c}}_{i} {e}^{- \frac{{‖ \overline{x} - {\overline{x}}_{i} ‖}^{2}}{2 {s}_{i}^{2}}}}{{\sum }_{i = 1}^{N} {e}^{- \frac{{‖ \overline{x} - {\overline{x}}_{i} ‖}^{2}}{2 {s}_{i}^{2}}}} \qquad ( 4 )$$

where {sᵢ}ₖ₌₁^{N} are the width of the Gaussian function and represent the nearest-neighbor distances of the inputs of the samples. However, other examples may apply different variations of ϕ.

Based on RBF convergence theory, if the synthetic input x is close to the input data in the training dataset {\vec{x}ᵢ}ᵢ₌₁^{i=N}, the output from Eq. 2 \vec{F}(\vec{x}) may be a satisfactory approximation to the true target value corresponding to the input data \vec{x}ᵢ. Subsequently, after being calculated in block 508, \vec{F}(\vec{x}) is augmented into core sample data set obtained by core laboratory 160 (e.g., referring to FIG. 1). Primary data augmentation technique 500 iteratively returns to block 502 to determine a new synthetic input \vec{x} in which Primary augmentation technique 500 repeats with a new input data The augmented core sample data set may be applied to petrophysical interpretation machine learning models.

In different examples, a principal component analysis (PCA) may be performed as a data augmentation technique. PCA may augment the core sample data set obtained by core laboratory 160 (e.g., referring to FIG. 1) by creating synthetic data in a latent space. For example, the latent space may be Fourier transformation domain of the sample data set obtained by core laboratory 160. The present disclosure utilizes PCA as the latent space of NMR T₂ distribution to illustrate data argumentation method. FIG. 6 shows NMR T₂ distributions for each input \vec{x}ᵢ in the sample data set obtained by core laboratory 160. Most of the T₂ distributions in the dataset have one dominant peak. If a synthetic T₂ distribution has multiple dominant peaks, it is an artifact. The present disclosure provides a technique to eliminate multiple dominant peaks.

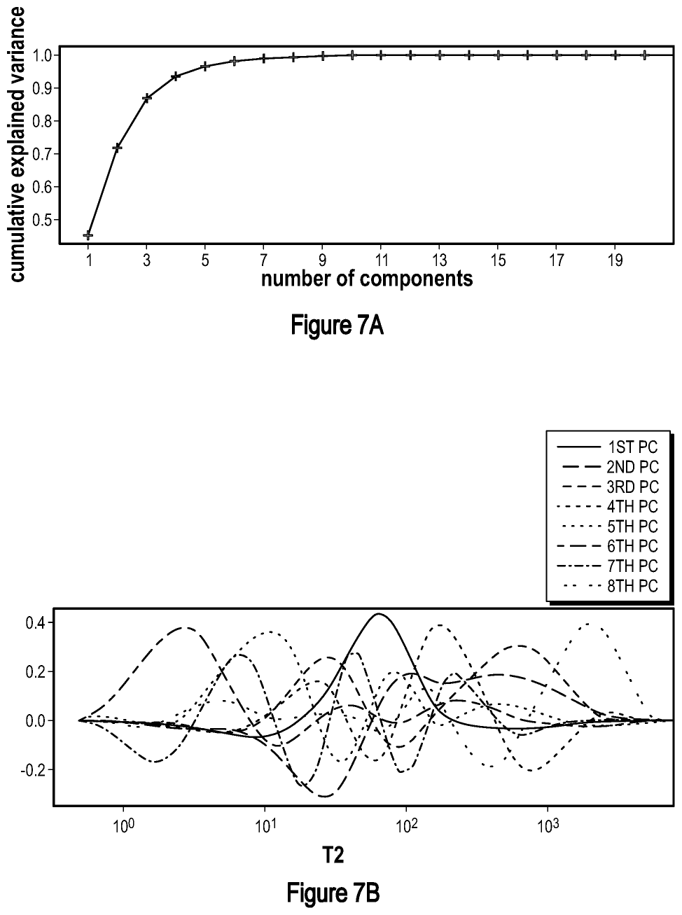

FIGS. 7A and 7B show the PCA transforms of T₂ distributions into a framework comprised of a set of vectors which are referred as principal components. The i^{th} principal component is denoted as PCᵢ. A T₂ distribution is projected onto the PCA framework, the projection on the i^{th} principal component (PCᵢ) is a coefficient, denoted as PCAᵢ. Then a T₂ distributions may be represented by principal component in the following form:

T₂ distribution=ΣPCAᵢ*PCᵢ (5)

where PCᵢ is a vector as shown in FIG. 7B, and PCAᵢ is the coefficient or projection of T₂ distribution onto PCᵢ.

FIG. 7A shows the first four Principal Components (PCs) which may account for over 90% variances of T₂ distributions of the training dataset, while the first eight PCs which may account for almost 100% variances. Each principal component PCᵢ in FIG. 7B captures various spectrums of T₂ distributions in the training dataset.

A synthetic T₂ distributions is created with the following:

Synthtic T₂ distribution=ΣPCᵢ*cᵢ (6)

where cᵢ, i=1, . . . , N are random positive values, and N is the number of principal components used to represent the T₂ distributions. The synthetic T₂ distribution created in Equation (6) may be augmented to core sample data set obtained by core laboratory 160 as a linear combination of PCᵢ. The augmented core sample data set may be applied to petrophysical interpretation machine learning models.

Utilizing these systems methods may be beneficial for modeling machine learning petrophysical models. Additionally, the disclosed systems and methods are improvements over the current art. For example, the synthetic data maintain the underline relationship between input and target data embedded in the original training data set as previously described in FIG. 5. Additionally, the synthetic input data (the second method) maintain fidelity to the original dataset as described in FIGS. 7A and 7B. An augmented core data set with a relationship between input and target data as well as fidelity to the original dataset is an improvement. Such augmented core data sets may be applied in petrophysical interpretation machine learning models. The systems and methods may include any of the various features disclosed herein, including one or more of the following statements.

Statement 1: The method may comprise forming a data set from one or more measurements of core samples, selecting one or more parameters from the data set, inputting the one or more parameters into a kernel estimation function, determining a kernel density estimation from the kernel estimation function based at least in part on the one or more parameters, and selecting an input value based at least in part on the kernel density estimation. The method may further comprise creating a corresponding synthetic target value based at least in part on the input value, augmenting the data set with the corresponding synthetic target value and input value to form a synthetic data set, and training a petrophysical interpretation machine learning model from the data set and the synthetic data set.

Statement 2. The method of statement 1, wherein the corresponding synthetic target value is created using a Radial Basis Function.

Statement 3. The method of statement 2, wherein the Radial Basis Function utilizes a vector formed from one or more constraints on a training data set.

Statement 4. The method of any preceding statements of claim 1 or 2, further comprising comparing the kernel density estimation to a threshold.

Statement 5. The method of statement 4, further comprising discarding the kernel density estimation if it is less than the threshold.

Statement 6. The method of statement 5, wherein the threshold is predefined and adjustable.

Statement 7. The method of any preceding statements of claim 1, 2, or 4, wherein the kernel density estimation comprises a kernel.

Statement 8. The method of claim 7, wherein the kernel is a Gaussian kernel, a linear kernel, or a cosine kernel.

Statement 9: A non-transitory computer-readable tangible medium comprising executable instructions that cause a computer device to form a data set from one or more measurements of core samples, select one or more parameters from the data set, input the one or more parameters into a kernel estimation function, determine a kernel density estimation from the kernel estimation function based at least in part on the one or more parameters, and select an input value based at least in part on the kernel density estimation. The executable instructions further cause the computer device to create a corresponding synthetic target value based on the input value, augment the data set with the corresponding synthetic target value and input value to form a synthetic data set, and train a petrophysical interpretation machine learning model from the data set and the synthetic data set.

Statement 10. The non-transitory computer-readable tangible medium of statement 9, wherein the corresponding synthetic target value is created using a Radial Basis Function.

Statement 11. The non-transitory computer-readable tangible medium of statement 10, wherein the Radial Basis Function utilizes a vector formed from one or more constraints on a training data set.

Statement 12. The non-transitory computer-readable tangible medium of any preceding statements 9 or 10, wherein the executable instructions further cause the computer device to compare the kernel density estimation to a threshold.

Statement 13. The non-transitory computer-readable tangible medium of statement 12, wherein the executable instructions further cause the computer device to discard the kernel density estimation if it is less than the threshold.

Statement 14. The non-transitory computer-readable tangible medium of statement 13, wherein the threshold is predefined and adjustable.

Statement 15. The non-transitory computer-readable tangible medium of any preceding statements 9, 10, or 12, wherein the kernel density estimation comprises a kernel.

Statement 16. The non-transitory computer-readable tangible medium of statement 15, wherein the kernel is a Gaussian kernel, a linear kernel, or a cosine kernel.

Statement 17. A method may comprise performing a principal component analysis (PCA) on one or more measurements of core samples to produce a set of vectors, combining each of the set of vectors to form a synthetic data, and augmenting the one or more measurements of core samples with the synthetic data.

Statement 18. The method of statement 17, further comprising eliminating multiple dominant peaks in a latent space with the PCA.

Statement 19. The method of any preceding statements 17 or 18, wherein the set of vectors are principal components of the (PC).

Statement 20. The method of any preceding statements 17-19, further comprising performing a linear combination of principal components.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
forming a data set from one or more measurements of core samples;
selecting one or more parameters from the data set;
inputting the one or more parameters into a kernel estimation function;
determining a kernel density estimation from the kernel estimation function based at least in part on the one or more parameters;
selecting an input value based at least in part on the kernel density estimation;
creating a corresponding synthetic target value based at least in part on the input value;
augmenting the data set with the corresponding synthetic target value and input value to form a synthetic data set; and
training a petrophysical interpretation machine learning model from the data set and the synthetic data set.

2. The method of claim 1, wherein the corresponding synthetic target value is created using a Radial Basis Function.

3. The method of claim 2, wherein the Radial Basis Function utilizes a vector formed from one or more constraints on a training data set.

4 The method of claim 1, further comprising comparing the kernel density estimation to a threshold.

5. The method of claim 4, further comprising discarding the kernel density estimation if it is less than the threshold.

6. The method of claim 5, wherein the threshold is predefined and adjustable.

7. The method of claim 1, wherein the kernel density estimation comprises a kernel.

8. The method of claim 7, wherein the kernel is a Gaussian kernel, a linear kernel, or a cosine kernel.

9. A non-transitory computer-readable tangible medium comprising executable instructions that cause a computer device to:
form a data set from one or more measurements of core samples;
select one or more parameters from the data set;
input the one or more parameters into a kernel estimation function;
determine a kernel density estimation from the kernel estimation function based at least in part on the one or more parameters;
select an input value based at least in part on the kernel density estimation;
create a corresponding synthetic target value based on the input value;
augment the data set with the corresponding synthetic target value and input value to form a synthetic data set; and
train a petrophysical interpretation machine learning model from the data set and the synthetic data set.

10. The non-transitory computer-readable tangible medium of claim 9, wherein the corresponding synthetic target value is created using a Radial Basis Function.

11. The non-transitory computer-readable tangible medium of claim 10, wherein the Radial Basis Function utilizes a vector formed from one or more constraints on a training data set.

12. The non-transitory computer-readable tangible medium of claim 9, wherein the executable instructions further cause the computer device to compare the kernel density estimation to a threshold.

13. The non-transitory computer-readable tangible medium of claim 12, wherein the executable instructions further cause the computer device to discard the kernel density estimation if it is less than the threshold.

14. The non-transitory computer-readable tangible medium of claim 13, wherein the threshold is predefined and adjustable.

15. The non-transitory computer-readable tangible medium of claim 9, wherein the kernel density estimation comprises a kernel.

16. The non-transitory computer-readable tangible medium of claim 15, wherein the kernel is a Gaussian kernel, a linear kernel, or a cosine kernel.

17. A method comprising:
performing a principal component analysis (PCA) on one or more measurements of core samples to produce a set of vectors;
combining each of the set of vectors to form a synthetic data; and
augmenting the one or more measurements of core samples with the synthetic data.

18. The method of claim 17, further comprising eliminating multiple dominant peaks in a latent space with the PCA.

19. The method of claim 17, wherein the set of vectors are principal components of the (PC).

20. The method of claim 19, further comprising performing a linear combination of principal components.
